(19) United States
(12) Patent Application Publication
(10) Pub. No.: US 2011/0178899 A1
(43) Pub. Date: Jul. 21, 2011

(54) BORROWING AND LENDING PLATFORM AND METHOD

(76) Inventor: Maria Huszar, Needham, MA (US)

(21) Appl. No.: 13/120,180

(22) PCT Filed: Sep. 25, 2009
(86) PCT No.: PCT/US09/58439

§ 371 Date: Mar. 22, 2011

Related U.S. Application Data
(60) Provisional application No. 61/100,081, filed on Sep. 25, 2008.

(51) Int. Cl. G06Q 30/00

(52) U.S. Cl. 705/27.2

(57) ABSTRACT

A platform or apparatus or method, creating a market through electronic, digital or computerized means with global reach for the temporary exchange of goods among individuals as well as organizations. Participant devices (e.g. computers) and a central platform (e.g. a website) are connected through a global communications network. The platform, apparatus or method establishes a borrower-lender relationship that allows the borrower to gain possession of said goods for a period of time while assuring the lender, through a binding agreement, of the safe and secure handling, and of the return, of the borrowed item. The invention serves as a depository of such offerings, as well as the vehicle for arranging the temporary exchanges of goods. For printed goods and other image-scannable (electronic captuarable) items, an alternative embodiment allows a borrower to temporarily access an electronic (image) copy of the subject good.

### RELATED APPLICATION

This application claims the benefit of U.S. Provisional Application No. 61/100,081, filed on Sep. 25, 2008.

The entire teachings of the above application(s) are incorporated herein by reference.

### FIELD OF THE INVENTION

The invention is a platform or apparatus, or method used for facilitating the informational search for, and the temporary exchange (borrowing and lending) of items among individuals and/or individuals representing organizations (collectively, hereinafter, “participants) through electronic means regionally or globally, without geographical restrictions. More specifically, the invention creates a ‘marketplace’ for temporary exchange of items (hereinafter, “items”) through the establishment of a central platform (e.g. a website and all its relating systems, such as databases, etc.) to which an unlimited number of participant devices (hereinafter also called “PDs,” e.g., computers) may be connected through a remote access global computer network (e.g. the Internet), communications network (e.g. mobile phones, TV, etc.), or other currently existing or not-yet existing network.

An embodiment of the present invention facilitates the borrowing and lending of rare, unique, collectible items, and any items that are not available en masse. Variations of the invention may facilitate the borrowing and lending of any items, whether they be commonly available or unique.

### BACKGROUND OF THE INVENTION

Rare, unique, collectible and commonly not available items have unique features, established high values, and potentially historical or other types of significance that make them desirable for a variety of people and/or organizations to have in their possession for a variety of reasons.

It is known that such unique items change hands through selling and buying through different venues. However, the prior art lacks in providing the opportunity for borrowing and lending such items among any individuals or organizations which borrowing and lending would establish only a temporary exchange of the items without the receiving individual or organization taking title of the item. For example, museums lend their collections to other museums, but they don't lend to just any “person” or organization.

The prior art provides for practices only where: (a) the borrowing takes place between a company (or other organization) and customers of the company (e.g. an individual borrowing a home improvement tool from a company); (b) people can arrange for borrowing items with a requirement of a physical appearance by the borrowing individual (or a representative) in order to take possession of and later return, the item; or (c) people participate in swapping items where they give away unneeded items to other people, and, in exchange, receive a different, potentially unrelated item. In this scenario, the items are not returned to the originating owners.

### SUMMARY OF THE INVENTION

Applicant finds that the prior art lacks established means to provide a platform that is generally accessible by any individual or organization, and which platform would provide the means to fulfill the full sequence of the borrowing and lending process without the need for the borrower or the lender to seek additional outside resources or services. This sequence may include steps from accessing the platform, to searching for and arranging the borrowing of an item, to the full completion of delivery and return of the borrowed item, to the use of a rating system of borrowers and lenders which helps in creating a trusted environment for the borrowing and lending process to be repeated unlimited times with the same or other items and between the same or other members.

In variations of the present invention, it is possible that outside sources, services and/or resources may be used in the borrowing and lending process; however, it is not a requirement.

Further Applicant finds that the prior art does not have a system established where the borrowing and lending takes place directly among the customers of a platform provider (an example of a platform provider could be a company), as opposed to the borrowing and lending taking place between platform provider and its customers.

Applicant has further discovered that the prior art does not have an established network, or even an established practice, where any adult individual or organization could become eligible to act as either or both a borrower and a lender at different times or simultaneously.

The prior art does not have a system established where an intermediary enables borrowers and lenders to search for each other, to find each other, to communicate with each other once found/matched, and to consummate a lending/borrowing transaction. Such transaction may be across a long distance and includes the originating owner (lender) promising to ship the agreed upon item to the borrower and the borrower promising to return the item in the same condition by the end of the agreed upon lending/borrowing time period.

The prior art also lacks the establishment of a platform where people could arrange borrowing and lending of items on a global scale and without geographical restrictions in regards to the originating destination and the borrowing destination of the items.

Furthermore, the prior art does not have an established system or network, which would provide a knowledge base of available items for borrowing. The freely available knowledge about a person or organization owning a specific item that is available for borrowing is currently very limited to local, informal levels. Even on a local level, such practice may be virtually non-existent or nearly non-existent because borrowing and lending unique (or common) items is not an established practice—partly due to the fact that the lack of such ‘marketplace’ is the reason that demand for such borrowing and lending has not developed; and therefore, has been virtually non-existent.

Thus, to address the shortcomings of the prior art, the present invention, described in this document, was developed. The objectives, descriptions, and explanations of the invention are presented below.

### ADVANTAGES OF THE INVENTION

Some of the objectives and advantages of the present invention are the following:

To establish a platform (such as a website or portal, with all its related and required elements) to provide the opportunity and the means for individuals and organizations to borrow and lend items they own, among each other, with a global reach, which borrowing and lending process establishes only a temporary exchange of the items without the receiving individual or organization taking title of the item.

To establish a platform (such as a website, with all its related and required elements) to provide the opportunity for a marketplace to exist where individuals and organizations have the opportunity to know what items other participants own that are available for borrowing and lending, among each other, with a global reach.

To establish a network (comprising individuals, organizations, systems and information) that provides the elements necessary for a marketplace to exist.

To establish an opportunity and practice for individuals and organizations to borrow and lend directly from each other on a global scale without the need to borrow from a formal entity or platform provider (such as a company)—while such individuals and organizations providing legal assurances to each other for complying with their borrowing- and lending-related obligations—through the agreements to which they obliged themselves at the time of registration through the platform provider (such as a company).

To establish a platform that provides for the full sequence of the borrowing and lending process to be executed by the members without the need to seek outside sources or services. Further detailed description is provided below, with the understanding that variations may occur.

To establish a platform where any member may act as either or both a borrower and a lender at any time, and simultaneously.

To establish a platform that provides global opportunity for borrowing and lending, for receiving information of the available items for borrowing and lending, and a global reach for any participant.

To provide a platform and establish the marketplace, through the platform where the existence of rare, unique and collectible items owned by individuals or organizations, as well as the borrowing availability of such items, can be made known without geographical limitations. Thus, creating not-yet existing demand for the borrowing and lending of such items on a local, regional and global scale.

To establish a platform and the marketplace where rare, unique, collectible items, and items not available en masse can be: (a) compiled in unlimited numbers, (b) the collection of this compiled and aggregated information can be made available and accessible to any individual or organization and (e) the items in the compiled list of available items can be offered for borrowing and lending globally.

To establish a platform that provides for the opportunity to embed, as a potential variable, an education element about the types of items being borrowed and lent, by incorporating various communication practices with participants as well as providing such aggregated information through the central platform or in other forms. In the present invention, blogs, newsletters, and other types of vehicles of knowledge distribution may be used, as well as specific areas of the central platform may be dedicated or used for such information. In variations of the invention, other already existent or not-yet existent communication vehicles may be embedded in the platform or used in various forms (such as through a website, through mobile phones, etc.). Such knowledge base may develop into a massive knowledge depository, rivaling or equaling academic, scientific, or otherwise respected and valuable collections of knowledge and information.

The foregoing objects and advantages of the invention are illustrative of those which can be achieved by the present invention, and are not intended to be exhaustive or limiting of the possible objectives and advantages that can be realized. Thus, these and other objectives of the invention will be apparent from the description herein, or can be learned from practicing the invention, both as embodied herein, or as modified in view of any variations which may be apparent to those skilled in the art. Accordingly, the present invention resides in the novel methods, arrangements, combinations, and improvements herein shown and described.

Some of the potential purposes and advantages of engaging in the invention system of borrowing and lending of items are stated in the following paragraphs.

The temporary exchange of items (borrowing and lending) can be more desirable than buying and selling for a number of reasons. The following list includes, but is not exhaustive of, reasons and purposes for which an individual or organization would prefer to borrow and lend items (as opposed to buying and selling items):
(a.) A researcher individual or organization has only a temporary need for having such an item in possession for purpose of analyzing it, studying it, and including conclusive knowledge in research results, publications, or other means of communication and scientific conclusions.
(b.) An enthusiast of a specific type of item may not have the financial means to purchase such items due to their high values and/or unavailability for purchase, but is able to borrow such items that provide such enthusiast with a memorable, life-time emotional experience as well as added knowledge about the item, gained through studying it in person, and having it in one's possession for a period of time.
(c.) An enthusiast may have the financial means to purchase an item, but not have the required storage facilities, as some of the rare items may have specific long-term storage requirements (e.g. a book form the 1800s should not be exposed to excessive light, and may need controlled humidity levels for long-term storage in order to preserve its condition). Such enthusiast is satisfied with the temporary possession of such items.
(d.) An enthusiast, who does not have a desire to buy or store such items, but enjoys the short-term presence of unique items.
(e.) A person may have only short-term need for a unique item. For example, a model-sized, miniature Christmas village that contains all elements of a real village (e.g. train tracks with trains, houses, stores, animals, etc.), and can be set up on top of a table or similar space is mostly significant only at Christmas time. Hence, the parents of young children may decide to borrow such a Christmas village to be set up as part of their celebration of the Christmas holiday, and to add to the holiday spirit. They would have no need for this item for the long-term.
(f.) Individuals or organizations may want to borrow a specific item for the celebration of an anniversary or special event. For example, a company or university may want to borrow a limited edition alumni yearbook, or the baseball jersey of its first baseball graduate, for its 100^{th} anniversary in order to showcase such items that originated with the university's first graduating class 100 years earlier. Another example would be a couple celebrating their 50^{th} wedding anniversary, and borrowing a unique lighting system for their entertainment needs that was once part of the sets of famous Hollywood movies,
(g.) Any individual or organization who has no intention of purchasing a temporarily needed item—unique or commonly available—but values the simplicity of arranging the borrowing through the platform, and having the item delivered to them; as well as being able to send the item back to the lender after the borrowing period without having to leave their premises.

### The Invention

The present invention is a platform that facilitates the borrowing and lending of items (for example, unique, rare and collectible items) between any individuals and/or organizations who are part of the network, created by the platform, and conform to certain requirements established by the service provider. The network is the sum of certain people, devices, information, and the platform (or invention), interacting through a global computer network (e.g. the Internet), communications network (e.g. mobile phones, etc.), or other already existent or not-yet existent network.

In the present invention, the individuals, and individuals representing organizations, (collectively, “participants”) connect to the most visible part of the platform, the central platform, which could take a variety of forms. For our illustrative example, the central platform is in the form of a website. The connection between the participants' devices (for our example, computers) and the website is made through a global network (for our example, the Internet). At any time, an unlimited number of participants may be connected to the website.

The platform—through the website, as initiated by the participants—may perform a number of functions that play the role of launching the appropriate processes in order to accomplish participants' desires, such as browsing the website, or the full sequence of arranging the borrowing of a specific item from another participant.

In the present invention, some of the functions are available to any participant, while other functions are available to registered participants (hereinafter, “members”). In variations of the invention, all functions may be available to all participants.

The website, as part of the platform, is provided by a platform provider, such as a company. The functions that launch the processes for searching the website, arranging the borrowing of a specific item, and other functions, are embedded in the website, and are initiated by the participants.

In one embodiment of the invention, the non-member specific content of the website is available for all participants to view, which includes the viewing of listed items available for borrowing, while the ability to arrange borrowing and lending transactions is available to members.

As used in the context of the invention, “transaction” refers to a temporary exchange (loaning with a return condition and a time limit condition) of an item between a member who posted an item on the central platform, acting as a lender, and a member who borrows such item, acting as a borrower for the temporary exchange of this particular item.

A member may post an item on the website to make it visible for all participants to see, and know that the item is available for borrowing. When posting an item, the member enters certain information about the item, such as its title, author, measurements, year of origination, description of the item, the self-guarantee amount (SGA), and others to provide information about the item to potential borrowers. The SGA serves as an assurance for the lender that, in the event a borrower defaults on the borrowing-related obligations, the lender will receive this, or part of this, SGA as conciliation for the default by the borrower. The SGA is more thoroughly explained under the ‘reserve account (RA)’ function in the Detailed Description section. An example of a posted item may be a book that was owned by Abraham Lincoln in the past, for which book the posting member enters all the required information, and deems the SGA (the value) of this book to be $4,000.

By many (ideally all) members posting items to make available for other members to borrow, the website serves as a depository of such offerings, as well as the vehicle for arranging borrowings and lendings.

One embodiment of the invention has three phases (the last of which phase (c) listed here is an optional phase). The phases are: (a) the search/peruse (or informational) phase, in which any participant (with a participant device) may participate; (b) the borrowing and lending phase, in which those participants who are current members of the service through having registered with the platform provider may participate; and optionally (c) the educational phase, in which the data, entered by members, as well as informational and educational information (such as information from the platform through blogs, newsletters, etc.) entered by the platform provider and/or its designees are compiled and potentially aggregated, and may serve as a depository of industry information.

In each borrowing and lending process, two members are involved; one of whom acts as the borrower, while the other member acts as the lender. The initiating member in a borrowing and lending transaction is always the borrower (however, in variations of the invention the lender may also initiate a borrowing and lending transaction).

### Search Phase

In the search phase, the invention serves as an agent for participants to search for and find items they may be interested in borrowing. This search function of the invention is available to any participant.

In the search phase, participants are able to search, browse and peruse a list, or lists, of items—and the specific information of each item—that members posted on the website as a manner of making known that such items are available for borrowing.

The search function may fulfill either a non-member or a member participant's interest in gaining knowledge of existing and available items for borrowing, as well as gaining specific information of such items; and a member's interest of finding desirable items for borrowing without signing in to the service, provided by the platform provider.

### Borrowing and Lending Phase

Beyond the search function, the invention embodies functions that, in one embodiment of the invention, are available exclusively to members.

In the embodiment of the present invention, a non-member participant may choose to register for the service the platform provider provides, to become a member and gain the rights to use the ‘member functions’.

To register to become a member, a participant connects to the website, and uses the registration function. During the use of this registration function, the participant provides the registration information as prompted by the website (e.g. full name, organization's name, address, phone number, etc.) and a chosen username and password for accessing the website in the future. The platform performs a check to ensure that no previously registered member has provided the same information. In the event that the same registration information already exists in the platform's database, the platform will notify the currently registering participant, and will not allow such participant to register with the already existing information. In such a case, either the current participant already registered in the past, and will be able to access the central platform with the already existing sign-in information (username and password) if such membership is still current, or another participant has already registered with the same information, and the current participant will not be able to continue the registration process with this information. This feature serves as a means of helping prevent the use of the platform through identity fraud. This feature of the registration process is one way of filtering the member base in order to build a trusted network to help ensure transactions with integrity among members. If the platform accepts the registration information of the participant, the participant becomes a member, and gains access to the ‘member functions’ area of the website as long as her registration remains current.

In one embodiment of the present invention, it is understood that only a member is able to enter the ‘member functions’; and therefore, the registration process must have been completed prior to attempting to enter the ‘member functions’.

Members, who own, or are the rightful representatives of the owners of items, can post such items on the website (e.g. a member posts a book on the website) for all participants to see such items and to know that such items are available for borrowing. For each item, the posting member fills out a post item form by entering the required information as prompted by the website. Such information may include the title of the item, author of the item, category as chosen by the posting member from a list of categories provided on the post item form, unique identifying number or other form of identification, date of origination, measurements, the self-guarantee amount (SGA) determined by the posting member, a description of the condition of the item, and other required information. Variations of the present invention may include other and more or fewer required information for posting an item.

The self-guarantee amount (SGA) is an amount, stated in the local currency as it applies to the version of the central platform used by the posting member, that the posting member deems as the value of the item. The SGA serves as an assurance for the lender that, in the event a borrower defaults on the borrowing obligations, the lender will receive the full or part of such SGA as conciliation for the default by the borrower.

For example, an item may be a book, for which its title, author, category (e.g. non-fiction), ISBN (International Standard Book Number), date of publication, weight, SGA (value), and a description of its condition are stated. All information entered at this time of posting an item is visible in the listings of the item, and can be accessed through the search/peruse function. In addition to this information, a photo of the item may be uploaded alongside the information.

In variations of the invention, other types of unique identifiers may be uploaded, such as a soundbite or other electronic or digital identifier of the item.

After the borrower finds a posted item—through the search/peruse function by searching or perusing—that he wishes to borrow, he selects a ‘request this item’ option (e.g., button) on the website, which launches the messaging process, and sends a message to the lender (the posting member).

The lender receives the message, and may review the requesting borrower's ratings posted by other members that reflect such other members' opinions of the requesting borrower's previous interactions with them. The lender may accept or decline the request. In either case, an automated message is sent to the borrower by the messaging function, once the lender clicks the appropriate button on the website.

In the event the lender accepts the borrowing request and the borrower is notified through the message, the borrower clicks a ‘borrow’ button on the website, and the platform checks the borrower's reserve account (RA) to verify the availability of sufficient funds for the self-guarantee amount (SGA) related to the item being borrowed, and for the costs of the shipping as well as for shipping insurance if required, for both ways of shipping the item between the lender and the borrower. (See below for more details about the ensuring of sufficient funds in the borrower's reserve account).

In the event of insufficient funds in the borrower's RA, the platform prompts the borrower to upload funds to satisfy the required amount. The platform does not allow the borrower to proceed until the required funds' availability is satisfied. Once the required funds are available, the platform withdraws the required amount form the borrower's RA, and notifies the borrower about the shipping label generation function's availability, for the purpose of this particular borrowing, for a limited time. In the embodiment of the present invention, the limited time availability of the shipping function serves the purpose of helping to prevent unauthorized use of the shipping label generating function, and in order to ensure that, in the event the borrower does not complete the borrowing process, the lender's item will become available for borrowing again to other members.

The borrower then accesses the shipping label generation function, and the platform generates the shipping labels, using the weight of the item to calculate the shipping costs, and the SGA to determine the requirement and/or the amount of shipping insurance. At the time of shipping label generation, the platform automatically calculates the date of shipping by the lender, and the date of the return shipping by the borrower. The platform automatically displays both of these dates in both the borrower's and the lender's profile, related specifically to this transaction and item that is being borrowed.

The borrower then sends the first shipping label to the lender through the messaging function. The lender then ships the item to the borrower on the designated date.

The borrower receives the item, and may keep the item until the designated ship back date. The borrower then ships the item back to the lender, using the return shipping label she generated.

The lender then receives the item, and inspects it for acceptable condition. If the lender deems the item to be in acceptable condition, he selects (e.g., clicks) a ‘received in acceptable condition’ option (e.g., button) on the website. The platform then automatically launches the ‘reserve account’ process, and credits the borrower's reserve account with the full SGA that was withdrawn at the beginning of the borrowing process.

If the lender believes that he received the item in a condition that is subpar to the condition in which he sent it to the borrower, and considers the current condition unacceptable, the lender notifies the borrower through the messaging system, and a resolution process starts between the borrower and the lender. In the embodiment of the present invention, the platform provider encourages members to resolve such disagreements between themselves. If, however, the borrower and the lender are not able to resolve the disagreement, they may contact the platform provider and ask to facilitate the resolution process. The platform provider takes an unbiased position, and facilitates the resolution between the borrower and the lender without the platform provider making a decision. In the unlikely event of fraud, the platform provider, however, will cooperate with the appropriate agencies. Once an agreement is reached between the borrower and the lender, both of them send a message to the service provider, stating their agreement, and the agreed upon amount of the SGA (if any) that should be credited back into the borrower's reserve account, and the remaining SGA to be credited into the lender's account as conciliation for the subpar condition in which he received the item back from the borrower. Both messages (from the borrower and the lender) to the service provider should include the same information regarding their agreement. These messages also serve as proof of the agreement. Once the service provider receives both messages, he directs the platform to perform the actions related to the SGA as described by both members in their messages.

The sequence of the requisite elements of the borrowing and lending process is completed with the above last process. An optional step, the rating and writing of a review of the counterpart member as well as the transaction, is encouraged by the platform provider for both the borrower and the lender to perform.

If either or both the borrower and the lender choose to perform this step, they may access the rating function that enables each member to rate the other on a measurable scale (such as a scale of 1-10), and to write a review of the interaction and experience with the other member. The review system serves as an important element in developing and maintaining a trusted network, in which members feel encouraged and confident to participate in the service the platform provider provides.

The completion of the rating and review of the counterpart member in a specific transaction fully completes such transaction. Members may seek other transactions, as well as they were able to seek other transactions at any time, even during the duration of this transaction. Each member may act either or both as a lender and a borrower at any time, and simultaneously.

### Educational Phase

In the educational phase, data and information entered by members about the items they posted, and other item and/or industry-related information entered into the platform by members, by the platform provider or its designees through the central platform (such as through blogs, newsletters, etc.) may be compiled and/or aggregated by the platform provider or its designees, and may be used as part of a depository of industry-related information which could potentially rival or be equal to large-scale and/or academic or scientific level and quality collection of information. Such information, or part of such information, in the depository may be made public by the platform provider, or made available to only selected individuals or organizations, or held in the platform provider's own depository for its own, exclusive use or non-use at all. Part of this information may be used by any participant, and other parts may be used only at the platform provider's discretion by only those individuals and/or organizations to whom the platform provider grants such rights. None of this information that is collected by the platform provider will include any member-specific or personal information. If any of the information provided by members, individuals or organizations contain personal or private or confidential individual or organizational information, the owner of the depository (most likely the platform provider) may make an effort to remove such information; however, is not obligated to do so.

The purpose of the educational phase and the depository information is to enrich members and the world with information that is not readily available (e.g. information about rare items). The compiled and/or aggregated information may serve individuals and organizations, as well as may become a potentially historically, scientifically, or otherwise significant compilation of knowledge.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

### Drawings of the Surrounding Environment of the Invention:

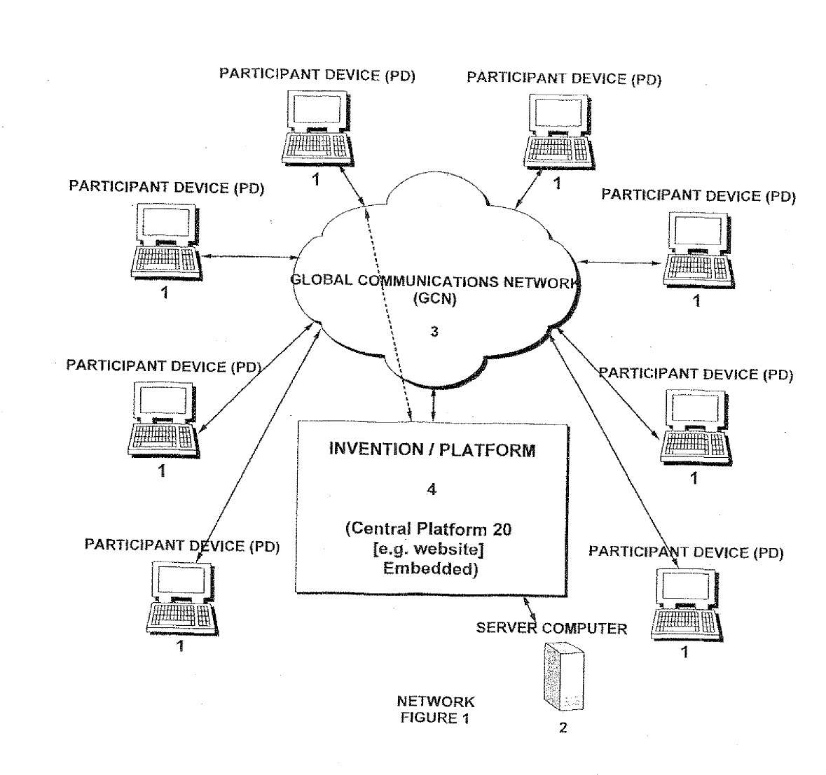

FIG. 1 is a schematic diagram of one embodiment of the invention in its surrounding environment.

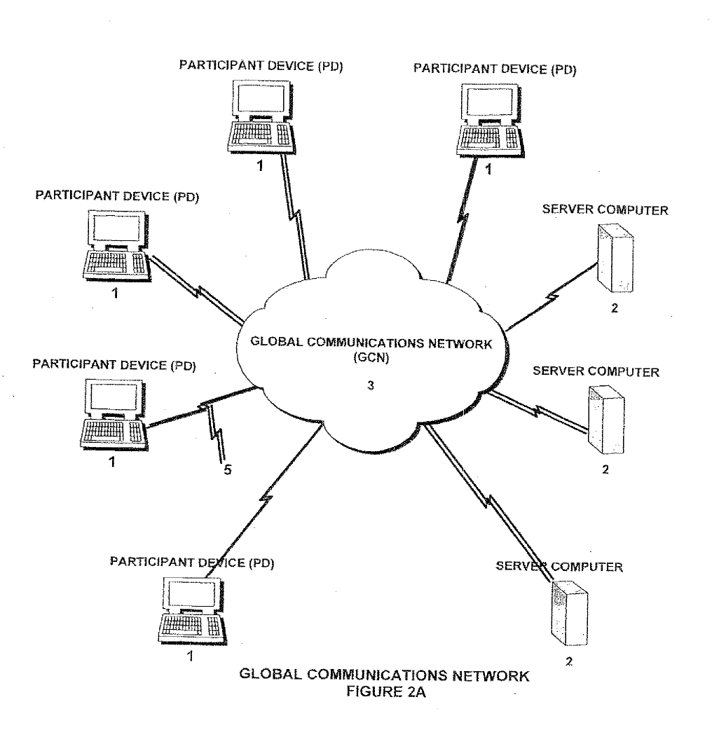

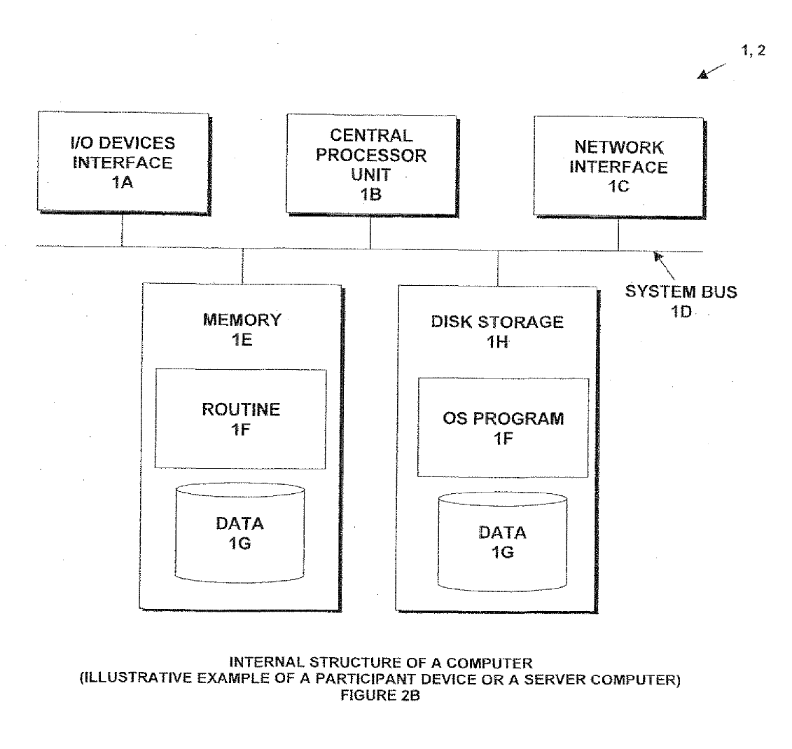

FIG. 2A is a schematic diagram of an illustrative computer network or similar digital processing environment, which serves as a connector between the invention and the participants.

FIG. 2B is a diagram of the internal structure of a computer, which is an illustrative example of a participant device or server.

### Drawings of Embodiments of the Invention:

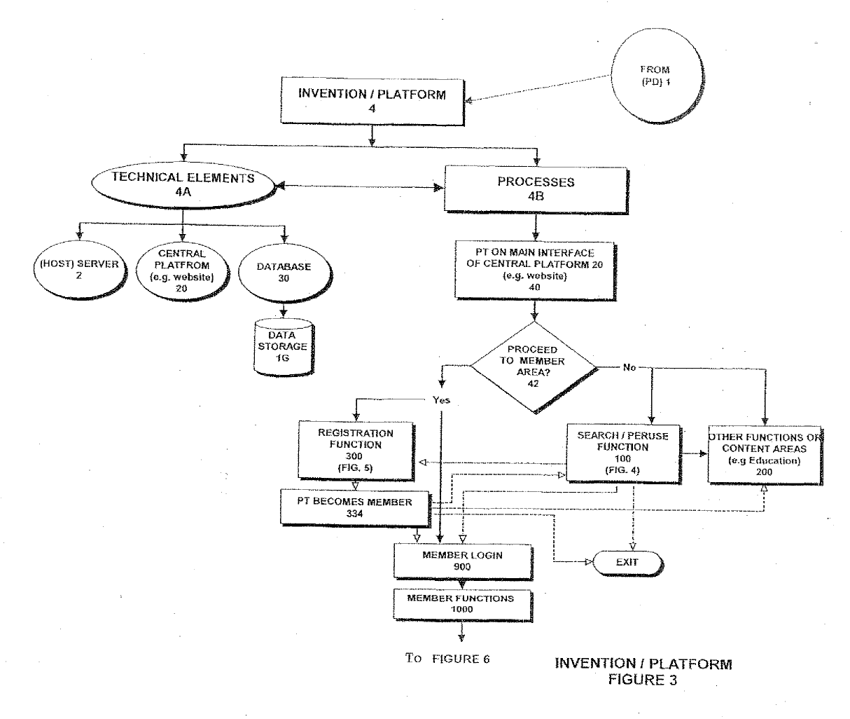

FIG. 3 is a schematic diagram of the structure of one embodiment of the invention.

### Drawings of the Functions of the Invention:

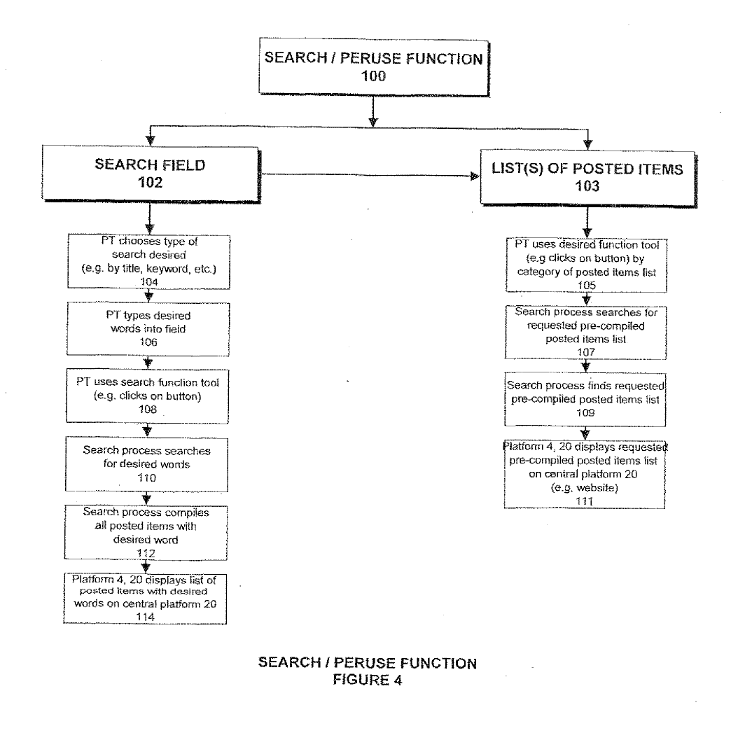

FIG. 4 is a schematic diagram of the logical flow of the ‘search/peruse’ 100 function of the embodiment of FIG. 3.

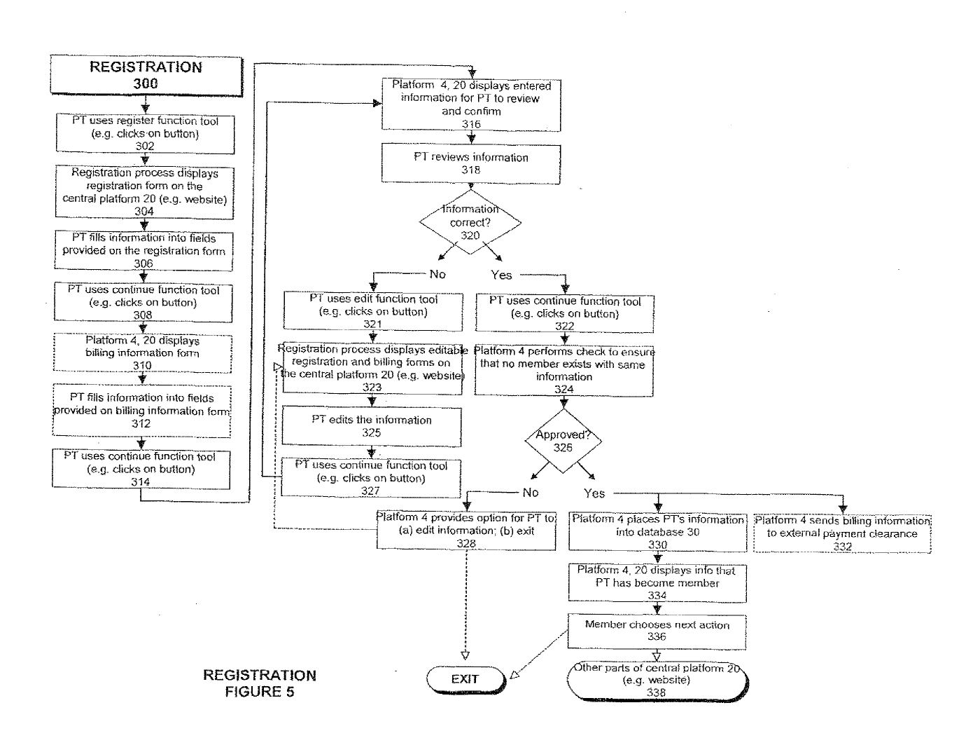

FIG. 5 is a schematic diagram of the logical flow of the ‘registration’ 300 function of the embodiment of FIG. 3.

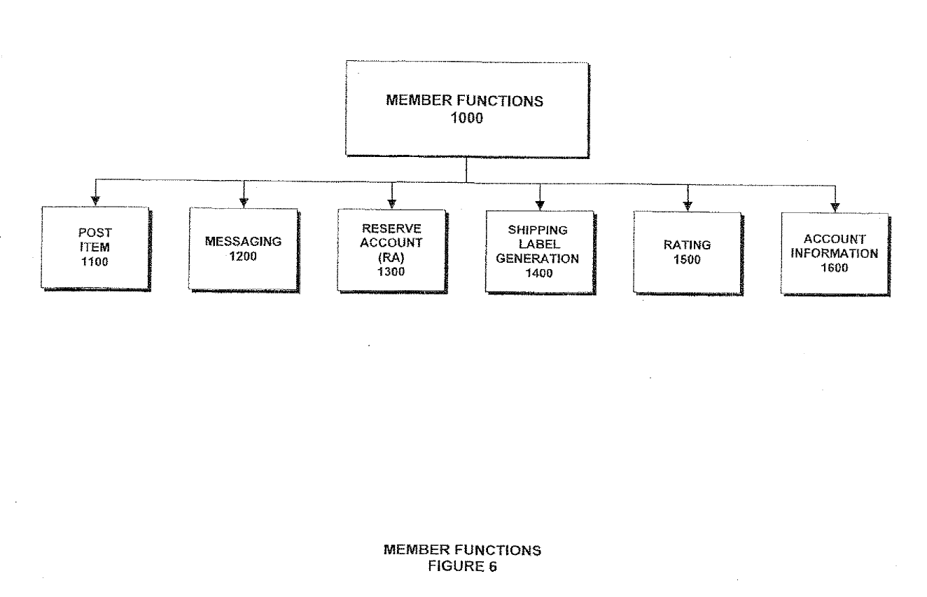

FIG. 6 is a schematic diagram of the ‘members functions’ 1000 of the FIG. 3 embodiment.

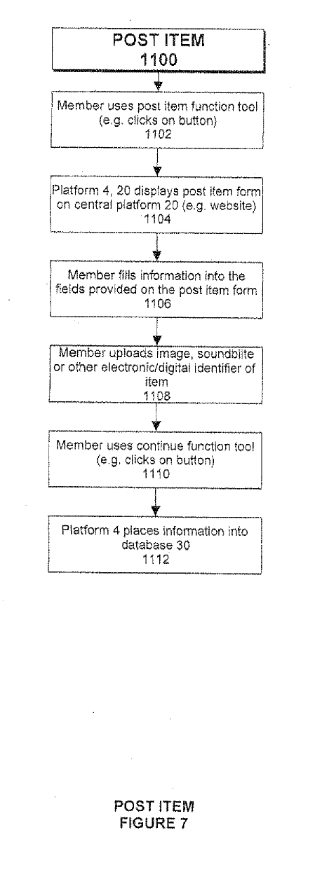

FIG. 7 is a schematic diagram of the logical flow of the ‘post item’ 1100 function of the members functions 1000 of FIG. 6.

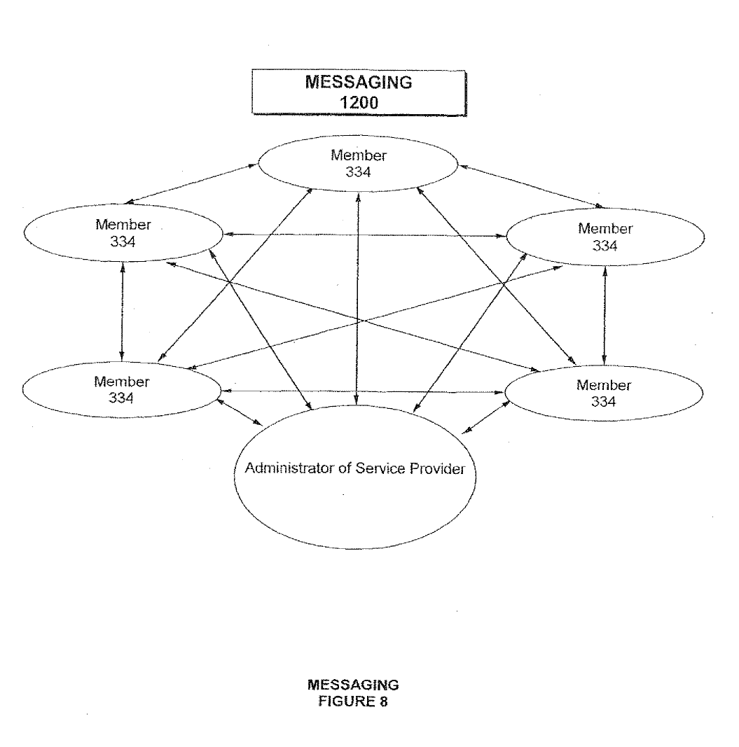

FIG. 8 is a schematic diagram of the ‘messaging’ 1200 function of the members functions 1000 of FIG. 6.

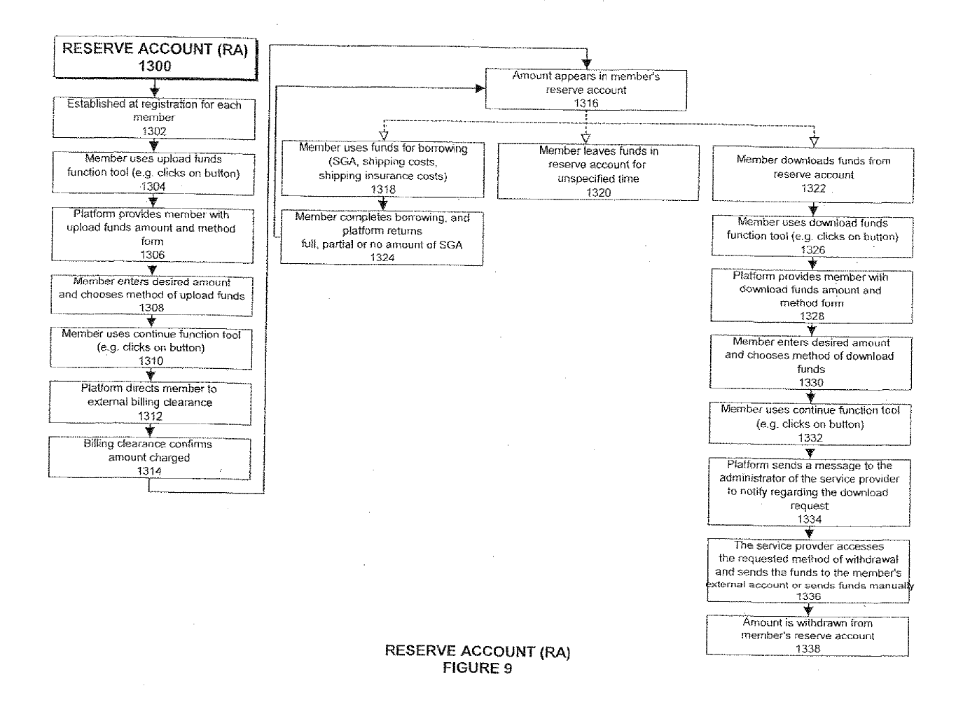

FIG. 9 is a schematic diagram of the logical flow of the ‘reserve account’ 1300 function of the members functions 1000 of FIG. 6.

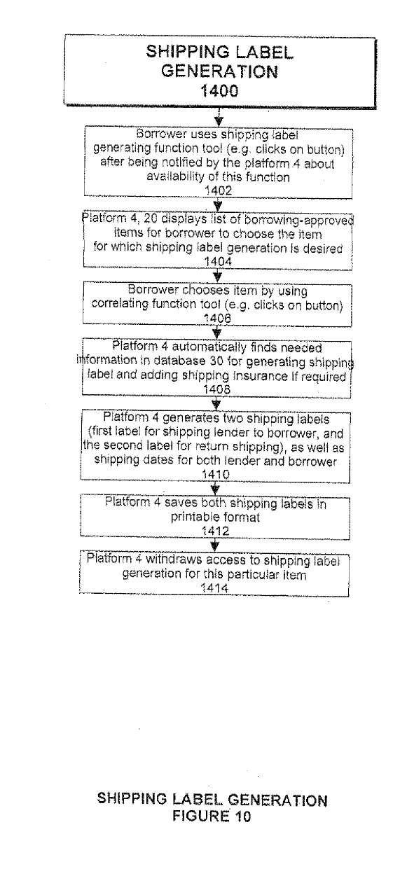

FIG. 10 is a schematic diagram of the logical flow of the ‘shipping label generation’ 1400 function of the members functions 1000 of FIG. 6.

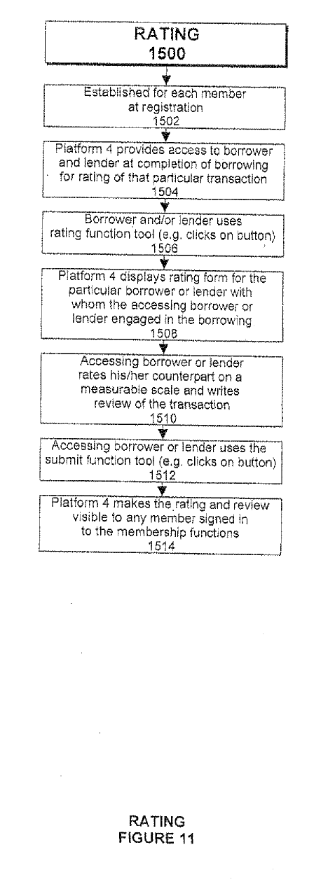

FIG. 11 is a schematic diagram of the logical flow of the ‘rating’ 1500 function of the members functions 1000 of FIG. 6.

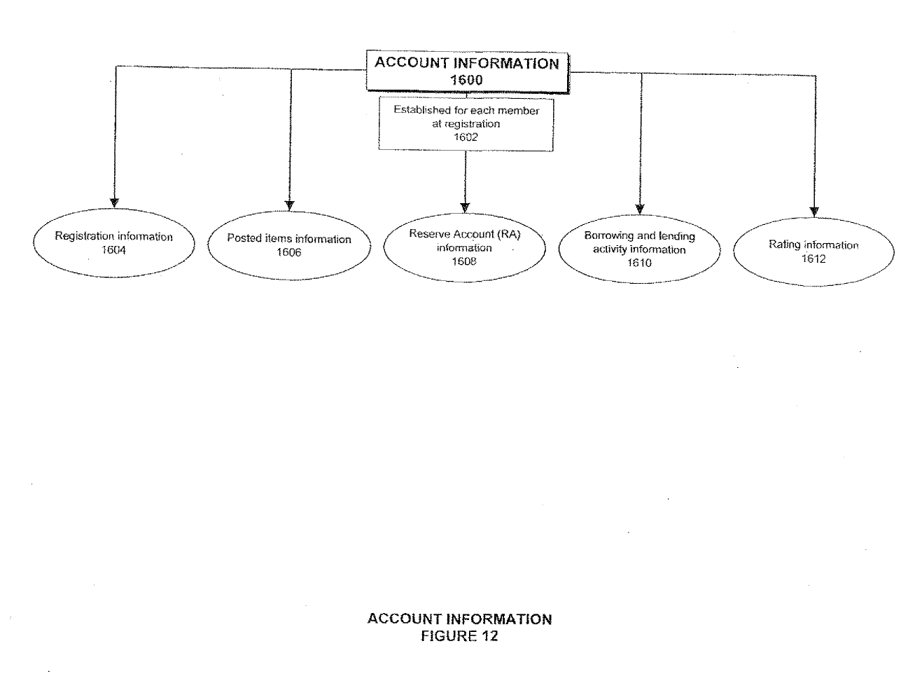

FIG. 12 is a schematic diagram of the ‘account information’ 1600 function of the members functions 1000 of FIG. 6.

### Drawing of the Borrowing and Lending Process of the Invention:

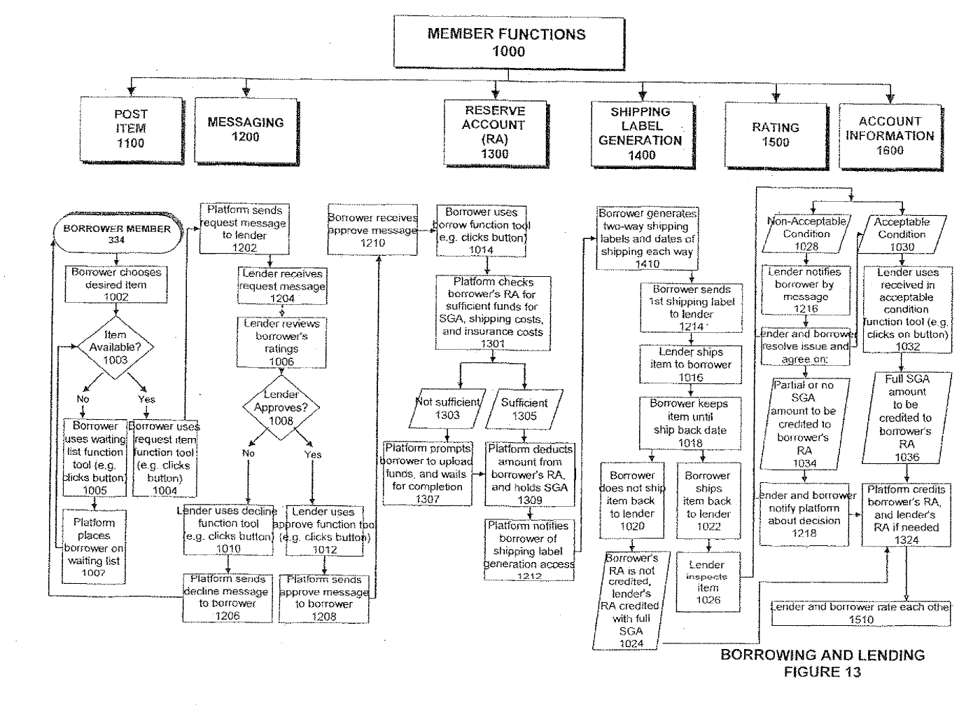

FIG. 13 is a schematic diagram of the logical flow of the ‘borrowing and lending’ process in embodiments of the present invention, accomplished through the members functions 1000 of FIGS. 3 and 6.

### DETAILED DESCRIPTION OF THE INVENTION

A description of example embodiments of the invention follows. Throughout the following discussion, reference is made to the various drawings in which dotted lines and arrows with unfilled heads represent optional actions. Broken line boxes represent non-requisite but preferred elements in embodiments of the present invention.

### Surrounding Environment of the Invention

It is understood that the invention will have a surrounding environment in which other objects of technology will be present. The embodiment of the present invention is designed in such a way that the central platform's (e.g. a website) content is easily accessible by established technology throughout the world. Potential variations of the platform and its surrounding environment are intended to present their contents through technological vehicles that are, or will be, accessible by then-current technology; or in the event of the needed technology not yet being widely available, such technology can be distributed to potentially interested participants.

FIG. 1 shows a schematic diagram of one embodiment of the invention 4 (hereinafter also called “platform” or “system”) in its surrounding environment. In this surrounding environment are participant devices 1 (e.g. mobile phones, personal data assistants, computers, etc.), servers 2 and a global communications network (e.g., the Internet) 3 (hereinafter also called “GCN”). The global communications network 3 may take different forms, such as the Internet, wireless network developed for cellular technology, and other technologies that are capable of transmitting information or data in various forms. The participant devices 1 may take different forms, such as computers, cellular telephones, and other already existent or not-yet existent devices. The server computers 2 may take a variety of forms, providing processing, storage, and input/output devices executing application programs, functions and the like, supporting operations of and providing the invention/platform 4. This surrounding environment may have unlimited numbers of the objects/devices in it, each of which may be interconnected to each other. It is understood that more than one type of participant device 1, and more than one type of global communications network 3 may be present in this environment and be connected to the invention. For example, a number of computers as well as a number of cellular telephones may be present, acting as participant devices 1; and, for example, the Internet as well as a cellular voice communications network may be present, acting as GCNs 3. For our illustrative example, computers are used as participant devices 1, and the Internet is used as a GCN 3. The purpose of this environment is the establishment of connection between participant device(s) 1 and the invention platform 4. The objects and the platform placed in this environment create a network, with no geographical or time restrictions.

FIG. 2A illustrates a computer network or similar digital processing environment, which serves as a connector between participants and the invention. Participant device(s) 1 (or “computer(s)”) and server computer(s) 2 provide processing, storage, and input/output devices executing application programs and the like. Computer(s) 1 can also be linked through communications network 3 to other computing devices, including other computer(s) 1 and server computer(s) 2. Communications network 3 can be part of a remote access network, a global network (e.g., the Internet), a worldwide collection of computers that enable communication and/or other types of interaction, Local area or Wide area networks, and gateways that currently use respective protocols (TCP/IP, Bluetooth, etc.) to communicate with one another. Other electronic device/computer network architectures are suitable.

FIG. 2B is a diagram of the internal structure of a computer (i.e., one of the types of potential participant devices 1 or server computers 2) in the computer system of FIG. 2A. Each computer 1, 2 contains system bus 1D, where a bus is a set of hardware lines used for data transfer among the components of a computer or processing system. Bus 1D is essentially a shared conduit that connects different elements of a computer system (e.g., processor, disk storage, memory, input/output ports, network ports, etc.) that enables the transfer of information between the elements. Attached to system bus 1D is I/O device interface 1A for connecting various input and output devices (e.g., keyboard, mouse, displays, printers, speakers, etc.) to the computer 1, 2. Network interface 1C allows the computer to connect to various other devices attached to a network (e.g., network 3 of FIG. 2A). Memory 1E provides volatile storage for computer software instructions 1F and data 1G used to implement an embodiment of the present invention (e.g., platform 4 processes and functions detailed below). Disk storage 1H provides non-volatile storage for computer software instructions 1F and data 1G. Central processor unit 1B is also attached to system bus 1D and provides for the execution of computer instructions.

In one embodiment, the processor routines 1F and data 10 are a computer program product (generally referenced 1F), including a computer readable medium (e.g., a removable storage medium such as one or more DVD-ROM's, CD-ROM's, diskettes, tapes, etc.) that provides at least a portion of the software instructions for the invention system.

Computer program product 1F can be installed by any suitable software installation procedure, as is well known in the art. In another embodiment, at least a portion of the software instructions may also be downloaded over a cable, communication and/or wireless connection. In other embodiments, the invention programs are a computer program propagated signal product 5 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 1F.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 1F is a propagation medium that the computer system 1 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

### EMBODIMENTS OF THE INVENTION

It is understood that the invention system (platform) 4 is formed of technical elements 4A and processes 4B. FIG. 3 shows a schematic diagram of the structure of the platform 4. The processes 4B are executed with the collaborative performance of the technical elements 4A; therefore, an interactive relationship exists between the technical elements 4A and the processes 4B.

The technical elements 4A include server(s) 2, central platform(s) 20 (e.g. a portal or website), and database 30 which may have various forms of data storage 1G.

In the embodiment of the present invention, the central platform 20 is in the form of a portal or website (hereinafter also called “website”). In variations of the present invention, the central platform 20 may take various forms (e.g. an interface developed for cellular telephones, etc.).

Once a participant (hereinafter also called “PT”), through a participant device 1 (hereinafter also called “PD”), is connected to the website 20 through a global communications network 3 (as shown in FIG. 1), the processes 4B are executed. In particular, a main interface of central platform (website) 20 is activated at 40 such that the PT is provided with function tools (e.g., a clickable button or user-selectable options on a website.) in purpose of accomplishing desired results within a specific function. A function is a means of executing processes designed to accomplish specific purposes or operations (such as the purpose of searching for items, or the purpose of requesting an item for borrowing, etc.), through the use of corresponding function tools.

At this time, the PT may choose 42 to proceed to the member area where, in the embodiment of the present invention, most functions are restricted to registered participants or to remain in the non-member area, in which, the search/peruse function 100 is available, as well as other functions or content areas 200. In the member area, depending on whether the PT is already a registered member, he may proceed to either the registration function 300, or to the ‘member functions’ 1000 which is available to already registered members. Each of these functions is discussed in more detail later.

If the PT chooses the search/peruse function 100, he may search, peruse or browse the items and/or list(s) of items that have been posted by members as a statement that such items are available for borrowing. Once the PT (who may be a non-member or a registered member) completes his activities with the search/peruse function 100, he may choose to proceed to the registration function 300 to register to become a member; or he may choose to proceed to the ‘member functions’ 1000 if he is already a registered member through the member login 900 function where he may enter the username and password chosen at the time of registration (or as the password may have been updated later through the account function 1600) to gain access to the members functions 1000; or he may choose to exit from the website.

If the PT visits the registration function 300, he may complete the registration form, and provide the required information in order to register to the service provided by the platform provider (in the embodiment of the present invention, the website provider). Once his registration is accepted by the website 20 provider, and the registration process is completed, he becomes a member 334. At this time, the member 334 may choose to proceed to the ‘member functions’ 1000, go back to the search/peruse function 100, go back to the other function/content areas 200, or exit.

In one embodiment, an education phase is provided at 200 and includes data and information entered by members about the items they posted and other items and/or industry-related information entered into the platform by members, by the platform provider or its designees through the central platform 20 (such as through blogs, newsletters, etc.). The data and information may be compiled and/or aggregated by the platform provider or its designees, and may be used as part of a depository of industry-related information which could potentially rival or be equal to large-scale and/or academic or scientific level and quality collection of information. Such information, or part of such information, in the depository may be made public by the platform provider, or made available to only selected individuals or organizations, or held in the platform provider's own depository for its own, exclusive use or non-use at all. Part of this information may be used by any participant, and other parts may be used only at the platform provider's discretion by only those individuals and/or organizations to whom the platform provider grants such rights. In some embodiments, none of this information that is collected by the platform provider will include any member-specific or personal information. If any of the information provided by members, individuals or organizations contain personal or private or confidential individual or organizational information, the owner of the depository (most likely the platform provider) may make an effort to remove such information; however, is not obligated to do so.

The purpose of the educational phase and the depository information is to enrich members and the world with information that is not readily available (e.g. information about rare items). The compiled and/or aggregated information may serve individuals and organizations, as well as may become a potentially historically, scientifically, or otherwise significant compilation of knowledge.

Functions of the Invention

In FIG. 4, the search/peruse function 100, serves as an agent for people to search for and find items they may be interested in borrowing. This search function of the invention is available to any participant (website 20 visitor/user).

Using the search/peruse function 100, participants are able to search, browse and peruse a list, or lists, of items, and the specific information of each item, that members posted on the central platform 20 (e.g. a website) as a manner of making known that such items are available for borrowing.

The search function 100 may fulfill either a non-member or a member participant's interest in gaining knowledge of existing and available items for borrowing, as well as gaining specific information of such items; and a member's interest of finding desirable items for borrowing without signing in to the service provided by the platform provider.

The search/peruse function 100 may be accessed in one of two ways: through a search field 102, or by viewing a list(s) of items 103 posted by members. The list(s) of posted items 103 may be accessed by using a function tool in the menu section of the central platform 20, or may be the result of the use of the search field 102.

If the PT chooses the search field 102 option to look for items, first she may choose the type of search desired 104. Such types of search may include category, keyword, title, author, and other types that are specified in the information given about the item at the time of posting the item (posting an item will be discussed in detail later). In variations of the embodiment of the present invention, choosing the type of search may not be necessary or available. After (or, alternatively, before) the PT chooses the type of search, she types the desired words into the search field 106. In variations of the embodiment of the present invention, additional options may be available to more specifically define the search criteria (e.g. exact word search versus words with misspellings, etc.). The PT then uses a function tool 108 (in one embodiment of the present invention, a clickable button), to launch the search process. The search process then searches for the words specified by the PT 110, using the search type specified by the PT at 104. Then the search process compiles all the posted items 112 that satisfy the PT's search specifications, and displays the resulting list of the search process on the central platform 114.

If the PT chooses to view already existing lists of items 103 residing in the central platform without the use of the search function 102, he may use a function tool 105 to choose the desired pre-compiled list. In one embodiment such lists are located for example, in the menu area of the website on the central platform 20. In the embodiment of the present invention, such pre-compiled lists may have been compiled by category of the posted items; however, in variations of the embodiment of the present invention, such pre-compiled lists may have been compiled by any other search type or criteria. The search process then searches 107 for the user-requested pre-compiled list, and finds the chosen pre-compiled list of items 109. In turn, search process 100 displays 111 this list on the central platform 20, and the PT may peruse such list.

Each way of accessing the search/peruse function 100 (either through the search field 102 or the list(s) of posted items 103) may be repeated unlimited times, and/or a PT may alternate between the use of these two ways of accessing the search/peruse function 100.

FIG. 5 is a schematic diagram of the logical flow of the registration function 300 of the invention. In the preferred embodiment of the present invention, participants may choose to become members in order to participate in the member functions of the central platform 20. To become a member, a PT is required to register with the service provider (typically the same as the platform provider,) in order to participate in the ‘member functions’ 1000 area of the central platform 20. Registering with the service helps ensure that the network may be a trusted network where members 334 feel comfortable to execute transactions with each other.

When a PT chooses to register to become a member, he uses a function tool 302 (e.g. a clickable button on website 20). Then the central platform 20 displays the registration form 304. The PT then fills the required information into the corresponding fields 306 provided on the registration form. In one embodiment of the present invention, the following information is required by the platform provider: PT first name, middle name, last name, organization's name (optional), street address, city/town, state/province, zip code or postal code, country, phone number, username chosen by PT, password chosen by PT, and e-mail address. Other communication addresses (text message number, mobile phone number, facsimile number, etc) and PT preference of which number/address to reach him, and the like are also suitable alternatives in embodiments of the invention.

In one embodiment of the present invention, the PT is required to acknowledge and accept the terms of use of the service provided by the service provider and other related legal obligations by placing a check mark into the appropriate field(s) in order to complete the registration. In variations of the present invention, some or all of the fields and/or the acknowledgement and agreement to the terms of use and/or the legal obligations may not be required.

Once the PT completes the registration form, he selects/operates the continue function tool 308 (e.g. a clickable button on website 20), and the platform 4, 20 displays the billing information form 310. The PT then fills the required information into the billing information form 312 in order for the PT to pay the required amounts for registration. In the embodiment of the present invention, the payment requirement for registration and the filling of the billing information form are preferred, but non-requisite elements. However, in variations of the embodiment of the present invention, such payments and providing the billing information may be requisite as well as non-requisite elements of the invention.

Once the PT completes the billing information form, he operates the continue function tool (e.g. clickable button on the website) 314, and the platform 4, 20 displays the information entered by the PT, 316 in order for the PT to review such information to ensure accuracy 318. The PT then decides whether the information is correct 320. If the information is not correct, the PT employs the edit function tool 321, after which the platform 4, 20 displays the editable registration and billing forms 323. The PT then edits the information 325, and then operates the continue function tool 327. The platform 4 then returns to the previous step of displaying the entered information for review 316, and the PT after reviewing the entered information 318 again, decides whether the information is correct 320.

If the information is correct (whether the PT edited the information previously or not), the PT operates the continue function tool 322, and the platform 4 performs a check to ensure that no previously registered member exists with the same information 324. The platform 4 then decides whether to approve the registration 326. If the platform 4 does not approve the registration because the same registrations information already exists in the platform's database 30, the platform 4 does not allow this participant to register with this already existing information. In such case, either the current participant already registered in the past, and will be able to access the central platform 20 with the already existing log-in information (username and password) if such membership is still current, or another participant has already registered with the same information, and the current participant will not be able to complete the registration with this information, as a means of helping prevent the use of the platform 4 through identity fraud. This feature of the registration process 300 is one way of filtering the member base in order to build a trusted network to help ensure transactions with integrity among members.

The platform 4 then provides the option to the PT to either edit the registration in case the PT entered mistaken information, or to exit the registration process 328. If the PT chooses to edit the information, the platform 4 returns to a previous step of displaying the editable registration and billing forms 323. After this step, the PT continues as described above, and proceeds to the platform's checking step 324 to ensure that no duplicate member information exists.

Once approved, the platform step 330 places the PT's information into the database 30, and if, in the current embodiment of the invention the billing form and information is a requisite element, then the platform 4 sends the billing information to external billing clearance 332. The platform 4 then displays a message that the PT has become a member 334. The member then chooses the next action 336: either to proceed to other parts of the central platform 20 (such as the ‘member functions’ 1000 or other non-member functions areas including educational phase, etc., as described above) 338, or to exit.

The platform provider may require a variety of activities on the part of a member to take in order to maintain membership. For example, the platform provider may require that members ensure that their registration information is always current, and in the event of changes in such information, the member must update such information. The platform provider may also require members to pay a certain amount of fee either or both at the time of registering to become a member and/or periodically after the time of becoming a member. In variations of the present invention, the platform provider may require other means and ways of maintaining current status of membership. These requirements are another way of filtering the member base, and helping ensure the existence of a trusted and secure network. In addition, the registration process 300 itself is an additional way to filter the member base and help ensure a trusted and secure network, as participants with trustworthy intentions are more likely to take the time and the action to register and to provide the registration information.

Once the participant becomes a member, this member is granted the right to use any of the functions (processes) in the ‘member functions’ 1000 area as designed by the platform 4.

In variations of the embodiment of the present invention, participants are not required to register to become members, and all functions may be available to all participants. In such variations, any participant may take part of the service, provided by the service provider through the invention system/platform 4.

FIG. 6 is a schematic diagram of the ‘member functions’ 1000 of the invention platform 4. In one embodiment of the invention, the ‘member functions’ 1000 includes a “post item” 1100 function, “messaging” 1200 function, “reserve account” (RA) 1300 function, “shipping label generation” 1400 function, “rating” 1500 function, and “account information” 1600 function. Each of these functions is described in detail below.

FIG. 7 is a schematic diagram of the logical flow of the “post item” 1100 function of the members functions 1000 of the invention. The “post item” 1100 function serves the purpose of enabling members to post items on the central platform 20 (e.g. a member posts a book on the website) for all participants to see such items and to know that such items are available for borrowing. It is understood that the member who posts an item is the rightful owner, or is a representative of the rightful owner of the item.

When a member chooses to post an item, she may operate the post item function tool 1102 (e.g. a clickable button on a website), which launches the post item process 1100. The platform 4 then displays the post item form 1104 on the central platform 20 (e.g. a website) with specific fields designated by the service provider to be filled in with the corresponding information. The member then enters the information into the fields 1106.

In the preferred embodiment of the present invention, fields may be included for entering the following types of information (each field available for one specific type of information):

title or name of the item (e.g. the title of a book.);

author of the item (e.g. the author of a book. However, this field is not required, due to the fact that some types of items may not have an author (e.g. an original advertisement print from the 1940s);

a list of categories determined by the service provider, from among which the member may choose the category in which the item best fits (this field may be required. e.g. books, old baseball cards, limited edition items of a specific brand, etc.);

a unique identifier number of any variation of alphanumeric information (e.g. the ISBN, or international standard book number, of a book. This field is not required due to the fact that some items may not have such a unique identifier.);

year of origination (e.g. the publication date of a book. This field is not required due to the fact that this information may not be available for some items);

weight of the item, stated in the local weight measurement units as it applies to the version of the central platform 20 the member is using (this is a required field in order for the shipping label generation 1400 function to calculate the appropriate shipping costs at the time this item may be borrowed);

the self-guarantee amount (hereinafter also called “SGA” determined by the member posting the item); and

a description of the item.

The SGA is an amount, stated in the local currency as it applies to the version of the central platform 20 used by the posting member, that the member deems as the value of the item. The SGA serves as an assurance by the borrower to the lender that, in the event the borrower defaults on the borrowing agreement, the lender will receive this, or part of this, SGA as conciliation for the default by the borrower.

Continuing with post item process 1100, in addition to the information entered into the field at 1106, the member may upload a photo of the item 1108 which will be included alongside the filled-in information when participants view the item. In variations of the present invention, a soundbite or other identifying electronic, digital, or other image, audio-visual or feature may be uploaded in addition to, or in place of, the photo image.

Once the member completes the post item form and the upload, he may operate the continue function tool 1110 (e.g. a clickable button on a website). The platform 4 step 1112 then places the information into the database 30.

Variations of the present invention may include other, and more or fewer, fields, uploading options, and/or required information for posting an item.

All information entered at the time of posting an item becomes visible in the listings of the items once the member completes the post item 1100 function. The item will become viewable through the search/peruse 100 function.

It is understood that the messaging 1200 function is useable between members, and between members and the service provider, as shown in FIG. 8. The main purpose of the messaging 1200 function is helping facilitate communications of the arrangements of borrowing and lending of items between members. Most uses of the messaging 1200 function are automated based on text message number, mobile phone number, email address and the like specified by the member at registration and stored in his profile and preferences in database 30, or such text message number, mobile phone number, email address and the like used only for automatic notification purposes by the platform 4, notifying the member of the receipt of messages, while the actual messages may remain on the platform to be viewed by the member after signing on to the platform. Most messages spawned by messaging function 1200 take place as a result of members' use of certain function tools. For example, a borrower-member may operate the ‘request this item’ function tool (a clickable button on website 20), which results in the platform 4 automatically sending a request message to the owner (or lender) of the item using the lender's specified preferred text message/email address/phone number, or the message remaining on the platform and an automated notification of the receipt of such message is sent to the specified preferred text message/email address/phone number. The automated execution of the messaging 1200 function may include an approval or decline of the requested item by the lender, a notification of the lender or borrower-member by the platform 4 in regards to insufficient funds in the borrower-member's reserve account (RA) 1300, a notification of a member by the platform 4 regarding the shipping label access availability, a notification of a member regarding the lender's dissatisfaction of the condition of a returned item, and various notifications between members or from the service provider to the members.

An additional, less used, purpose of the messaging function is to enable members and the service provider to communicate in the unlikely event that the service provider's assistance is requested by a member for the facilitation of resolving disagreements with another member. The service provider is not intended to make judgments or decisions, but is only intended to facilitate the resolution of disagreements and the making of decisions between members. In addition, the messaging 1200 function also serves a purpose of the service provider's sending service-related, industry-related or account-related messages to members. In the preferred embodiment of the present invention, the main purpose of the messaging 1200 function remains the facilitating of borrowing and lending arrangements. The logical flow of the use of the messaging function 1200 is demonstrated in FIG. 13, which is a schematic diagram of the logical flow of the borrowing and lending process through the members functions 1000 of the invention. In variations of the embodiment of the present invention, the messaging 1200 function may serve other purposes, and may have other uses, or no uses at all.

FIG. 9 is a schematic diagram of the logical flow of the reserve account (RA) 1300 function of the members functions 1000 of the invention. The reserve account (RA) 1300 function serves two purposes in the embodiment of the present invention. One purpose is to facilitate an assurance by the borrower to the lender that the borrower will return the borrowed item, and will return it in satisfying condition. Another purpose is to facilitate payment for shipping costs associated with the shipping of a borrowed item from the lender to the borrower as well as from the borrower to the lender at the time of return shipping of the item, and for facilitating payment for shipping insurance costs if required by the platform 4 or by the lender. Other purposes may be instituted in future embodiments of the invention.

A reserve account is established at the time of registration 300 for each newly registered member. A member may upload funds into his/her reserve account through the vehicles the service provider provides on the central platform 20. In one embodiment of the present invention, such vehicles may include credit card processing, bank transfer, payment from a member's outside financial or investment institutions account to the service provider's outside financial or investment institutions account. In variations of the invention, more or fewer vehicles may be used for uploading and downloading funds. In another embodiment, RA 1300 funds may be provided through a business or adjunct partner of platform 4 provider in various units, virtual money or other currency having a cash equivalent. Other variations and configurations of RA and its tools are suitable.

Each time before a borrower is granted the request of borrowing an item, the sum of the self-guarantee amount (SGA), the shipping costs, and the shipping insurance costs are withdrawn from the borrower's reserve account. The SGA is an amount, stated in the local currency as it applies to the version of the central platform 20 used by the posting member, that the member deems as the value of the item. The SGA serves as an assurance by the borrower to the lender that, in the event a borrower defaults on the borrowing agreement, the lender will receive this, or part of this, SGA as conciliation for the default by the borrower.

While an SGA amount is withdrawn from the borrower's RA, and is being held by the service provider, such amount of that particular SGA is not available for the borrower to use for the SGA requirement or shipping costs or shipping insurance costs of any other borrowings, nor is it available for downloading (withdrawing) it from the RA. Once the borrower returns the borrowed item, and the lender acknowledges its receipt in satisfying condition, the SGA is credited back into the borrower's reserve account.

If the item is not returned in satisfying condition, the borrower and lender will engage in a resolution process (as described in more detail below), and the SGA, or part of the SGA, or none of the SGA will be credited back into the borrower's account when the borrower and the lender arrive at a mutual agreement regarding the amount (if any) to be credited back to the borrower's RA. A member may download (or withdraw) available funds from his reserve account any time through the vehicles the service provider provides on the central platform 20.

It is understood that the reserve account (RA) is established for each member at the time of registration 1302 automatically by the platform 4. Once the member's reserve account is established, he may click on or otherwise operate the upload funds function tool 1304. The platform 4 then displays the upload funds amount and method form 1306. The member enters the desired amount to be uploaded into the corresponding field, and chooses the desired method of uploading 1308. Once the member completes this form, he may click on the continue function tool 1310. The platform then directs the member to an external payment clearance 1312, specific to the method the member chose. The external billing clearance confirms the amount charged 1314, and the appropriate amount appears in the member's reserve account 1316.

When available funds are present in a member's RA, he may choose one of three options at any time. The member may use some or all of the funds for borrowing items (securing the SGA, paying for the shipping costs and shipping insurance costs, and or purchasing apparel, gift or other items that bear the service provider's logo or other information, which items are provided by the service provider for sale 1318. The reserve account funds can be used for other purposes as well. If the member chooses this option for borrowing arrangements, the full or partial SGA will be returned to his RA 1324 once the borrowing process is completed and the lender agrees that the borrower retuned the item in the condition the lender accepts (see more details later).

Another option the member may choose is to leave the funds in his reserve account for unspecified time period 1320.

The third option a member may choose is downloading funds form his RA 1322. In this case, the member may operate the download funds function tool 1326. The platform 4 then displays the download funds amount and method form 1328, and the member enters the desired amount and chooses the method of downloading 1330. Then, the member may operate the continue function tool 1332. The platform 4 then sends a message to the service provider, notifying the service provider regarding the download request 1334. The service provider then accesses the requested method of withdrawal, and sends the funds to the member's personal account 1336. This step may also be executed by preparing and sending a check to the member's physical address. Following this step, the amount is deducted from the member's reserve account 1338.

It is understood that the shipping label generation 1400 function, as shown in FIG. 10, provides for the purpose of generating the shipping labels, through the central platform 20, necessary for the shipping of borrowed items from lender to borrower, and from borrower to lender. The shipping label generation 1400 function is embedded in the central platform 20, and borrowers are granted access once each borrowing has been approved by the lender, and the correlating funds have been withdrawn from the borrower's reserve account 1330. The borrower is responsible to pay for the costs of shipping each way between borrower and lender. Since each member may act as either or both a borrower and a lender, a member acting as a borrower will incur shipping costs, while at time of acting as a lender will not incur shipping costs.

FIG. 10 is a schematic diagram of the logical flow of the shipping label generation function 1400 of the ‘member functions’ 1000 of the invention. Once a member is notified that the shipping label generation function 1400 is available for an approved borrowing, the member may operate the shipping label generation 1400 function tool 1402. The platform 4 displays a list of borrowing-approved items for which shipping label generation is available 1404. The borrower chooses the item for which he desires to generate the shipping labels 1406.

The platform 4 then compiles all the information necessary for generating the shipping labels for that specific item 1408. Such information may include both the borrower's and the lender's names and addresses; the weight of the item to calculate the shipping costs, the SGA of the item to decide whether shipping insurance is required by default in the central platform 20 as determined by the service provider, and a potential lender requirement for shipping insurance in the event shipping insurance is not required by default by the central platform 20. In the embodiment of the present invention, shipping insurance is required by default for any item that has an SGA of $100 or higher. If an item's SGA is lower than $100, the lender may require shipping insurance.

The platform 4 then generates two shipping labels: one for shipping from the lender to the borrower, and another one as the return shipping label from the borrower to the lender; as well as the shipping dates for each way of shipping 1410. The shipping dates are generated by the platform based on specifications previously programmed into the platform 4 by the service provider. In the embodiment of the present invention, the shipping date for the lender is the business day following the shipping label generation; and the shipping date of the return shipping by the borrower is typically the number of days the shipping takes from lender to borrower plus the number of days of the allowed borrowing time. The default programming for the date generation may be changed any time by the service provider.

In variations of the embodiment of the present invention, the date generation may be omitted, the specification of an allowed shipping time period may be omitted, as well as the shipping label generation function 1400 may be omitted. However, embedding the shipping label generation function provides a service to members that ensures that the full sequence of the borrowing and lending process can be processed without such member having to seek outside sources or services, and potentially, without such members leaving their locations, as some of the shipping providers may offer pick up services at the shipper member's location. The platform 4 saves both shipping labels in printable format 1412, and withdraws access to the shipping label generation 1400 function for this particular item 1414.

In one embodiment, an alternative feature is provided for printed items and other image scannable (electronic capturable) items being borrowed. Instead of shipping the hardcopy of the subject item, platform 4 allows the lender to generate and upload an image file (e.g., PDF) or similar digital data copy of the subject item. Other file types, forms or formats are suitable including sound/audio files, video files, etc. and their respective various formats. Platform 4 stores the image file/digital data copy (generally “soft copy” or “electronic copy”) in database 30 and allows secured, time-delimited access to the subject image file by a borrower. For example, steps similar to steps 1402, 1404, 1406 and 1408 of the shipping label generation function 1400 may be employed. Then instead of platform 4 generating shipping labels at step 1410, platform 4 may generate and transmit to the borrower a password protected, read-only, non-copyable image file of the subject item (i.e., a copy from that stored in database 30) or a link (password protected and time-delimited) to such an image file copy. The access level may limit the borrower from downloading the image file/electronic copy to prevent the borrower from storing/having a copy beyond the borrowing terms. The time delimits of authorized access by the borrower are calculated similarly to the shipping dates of step 1410. After the return ship date, the password, link, etc. expire and prevent the borrower from further accessing the electronic copy of the subject item. Known techniques are used for limiting access, for limiting copying and/or downloading and for providing security of access.

To facilitate the lender in generating the electronic/softcopy for upload to platform 4, image scanner (or other suitable) equipment may be made locally available to the lender. This is accomplished through qualifying third-parties that provide image scanning services and/or equipment (e.g., a local curator), or the platform 4 service provider providing image scanning services to the lender, or the lender himself already having suitable image scanning equipment, or the like. Various vendor arrangements and computer image-scanning (or other file/electronic copy generating) configurations are contemplated.

FIG. 11 is a schematic diagram of the logical flow of the rating 1500 function of the members function 1000 of the invention. The rating 1500 function serves the purpose of developing a trusted network by enabling members to rate each other, based on their interactions and on their level of satisfaction of their obligations to each other during borrowing and lending processes. Each member may rate only another member with whom she conducted a borrowing and lending transaction. The rating system 1500 provides for the capability of a member to rate another member on a measurable scale (e.g. a scale of 1-10), and to write a review of the interaction with the other member. A member may use the rating information of a potential borrower, or a lender, in deciding whether she will choose to engage a borrowing and lending transaction for a specific item with that specific borrower or lender. This rating feature serves as a self-filter, as it encourages members to act by fulfilling their obligations, and to act with integrity that helps develop a trusted network.

The rating 1500 function is established for each member at the time of registration 1502. This function provides for the member to rate other members after transactions with such other members, and to receive ratings and reviews by other members after transactions with such other members. In the embodiment of the present invention, ratings and reviews cannot be deleted by members.

Once a borrowing and lending transaction is completed, the platform 4, 20 provides access for each, the borrower and the lender, to rate and write reviews of the completed transaction 1504. The borrower and/or the lender may operate the rating function tool 1506, and the platform 4, 20 displays the rating and review form 1508. The accessing borrower or lender rates her counterpart member on the scale provided by the platform, and writes a review of the transaction and the interaction 1510. The rating member then operates (clicks) the submit function tool 1512, and the platform 4 stores the rating information per member as shown at 1612 (FIG. 12). Platform 4 may utilize the rating information 1612 for certain displays/screen views in central platform 20 during interaction with system users (members) as will be made clear below. Continuing with FIG. 11, Step 1514 makes the rating and review visible to any member who is logged in to the members function 1000 area of the central platform 20. In variations of the invention, such ratings and reviews may be visible to all participants.

FIG. 12 is a schematic diagram of the account information 1600 function of the members functions 1000 of the invention. The account information 1600 function provides each member with the capability to view his information, specific to his membership, and related activities. The account information 1600 function is established at the time of registration for each member 1602. The account information 1600 function may provide current (and potentially, but not requisitely past) information regarding the member's: registration information 1604, posted items information 1606, reserve account (RA) information 1608, borrowing and lending activity information 1610, and rating information 1612. The registration information 1604 is maintained and regulated through registration function 300 and stored in database 30. The posted items information 1606 is from the posted item process 1100 sessions by the member with session results stored in database 30. The reserve account information 1608 is maintained and updated by reserve account function 1300. The borrowing and lending activity information 1610 is from borrowing and lending sessions (FIG. 13) described below. The rating information 1612 is supported by rating function 1500. In variations of the embodiment of the present invention, these groups of information may appear in different grouping, forms or under different names, or such information may be deleted or expanded with additional information.

Borrowing and Lending Process

FIG. 13 is a schematic diagram of the logical flow of the borrowing and lending process, accomplished through the members functions 1000 of the invention. For a given member, details and steps of each of his borrowing and lending sessions are logged at 1610 (FIG. 12). In any particular borrowing and lending process session, two members are involved; one of whom acts as a borrower, and the other member acts as a lender. In the embodiment of the present invention, the initiating member in a borrowing and lending process is the borrower. In variations of the invention, it is possible that lenders may approach potential borrowers with the purpose of engaging in a borrowing and lending transaction.

A waiting list serves the purpose of borrowers being able to reserve a posted item if such item is currently lent to another borrower, and therefore, is unavailable. The waiting list also serves the purpose of creating a list of borrowers, desiring to borrow a specific item, in the order such borrowers request enlisting on the waiting list. Therefore, such order in the waiting list ensures fairness among borrowers desiring to borrow a specific item.

The borrower 334 finds a posted item (through the search/peruse function 100 by searching and/or perusing the posted items) that he wishes to borrow 1002. Database 30 associates or effectively links the posted item to the corresponding lender who posted and owns the item and links to other current details about the item (i.e., availability as determined from Borrowing and Lending activity information 1610 of the lender). The borrower may see the availability of such item 1003, which is listed among all other information, specific to the item. If the item is currently not available for lending due to such item currently being lent to another borrower, the borrower may use the waiting list function tool (e.g. clicks on a button) 1005, and the platform 4 places the borrower on a waiting list 1007. In the preferred embodiment of the present invention, the waiting list is offered to members. However, such waiting list is not a requisite element of the invention; and, in variations of the embodiments of the present invention, such waiting list may be offered in different manners, or not offered at all. Once the item becomes available for the borrower; or if the item is currently available without the use of the waiting list, the borrower then operates a ‘request this item’ function tool 1004 (e.g. a clickable button on a website) on the central platform 20, which launches the messaging process 1200, and sends a request message to the lender 1202.

The lender receives the message 1204, and may review the requesting borrower's ratings 1006 posted by other members previously, which ratings reflect the other members' opinions of the borrower's previous interactions with such other members. Rating information 1612 of the borrowers account 1600 supports this viewing 1006. In embodiments of the present invention, this action is not a requisite step in the borrowing and lending process, although it is a likely step a lender performs.

The lender then decides 1008 whether he approves the borrowing request by such requesting borrower 334, and uses either the decline function tool 1010, or the approve function tool 1012 on the central platform 20. If the lender declines the request, the messaging function 1200 sends a decline message 1206 to the requesting borrower 334. In such event, there are no additional steps, and this particular borrowing and lending transaction or session is completed. The borrower 334 may, however, initiate other borrowing and lending processes with the same or other lenders.

In the event the lender approves the borrowing request at decision junction 1008, indicated by his use of the approve function tool 1012, the messaging function 1200 sends an approval message to the requesting borrower 1208. After the borrower receives the message 1210, he operates the ‘borrow’ function tool 1014 on the central platform 20, and the platform 4 checks the borrower's reserve account (RA) 1608 to verify the availability of sufficient funds 1301 for the self-guarantee amount (SGA) related to the item being borrowed, for the costs of the shipping, as well as for shipping insurance if required, for both ways of shipping the item between the lender and the borrower. Database 30 holds this information for the subject item.

Each time before a borrower is granted the request of borrowing an item, the sum of the self-guarantee amount (SGA), the shipping costs, and the shipping insurance costs (if any) are deducted from the borrower's reserve account 1318 (FIG. 9). The SGA is an amount, stated in the local currency as it applies to the version of the central platform 20 used by the posting member, that the member deems as the value of the item. The SGA serves as an assurance by the borrower to the lender that, in the event the borrower defaults on his borrowing obligations, the lender will receive this, or part of this, SGA as conciliation for the default by the borrower. In one embodiment of the invention, shipping insurance is required for an item with an SGA of $100 or higher (this amount is adjusted to local currency in variations of the central platform 20 operating in localities with different currencies, and/or is adjusted according to local monetary conditions).

In order for the platform 4 to know the exact required amount to be withdrawn from the borrower's RA 1608 for a particular borrowing, and to know whether the available funds in the borrower's RA 1608 are sufficient for the currently lender-approved borrowing, the platform 4 checks the SGA of the particular item for the required SGA, and for whether shipping insurance is required based on the amount of the SGA, and calculates the shipping insurance amount based on the shipping insurance rates stored by the platform 4, previously provided by the shipping insurance provider. The platform 4 also checks the weight of the item (which was entered by the lender at the time of posting the item through function 1100—see step 1106, FIG. 7, and stored in database 30) to calculate the required amount for the cost of shipping.

The platform 4 then provides the result that the funds in the borrower's RA 1608 are either: not sufficient 1303; or sufficient 1305. In the event of insufficient funds in the borrower's RA 1608, the platform 4 prompts the borrower to upload funds to satisfy the required amount, and waits for the action to be completed 1307. The platform 4 does not allow the borrower to proceed until the availability of the required funds is satisfied. Once the borrower uploaded sufficient funds (through reserve account functions 1300), or if the result of the platform check was sufficient funds 1305 in the borrower's RA, the platform 4 deducts the sum of the SGA, the shipping costs and shipping insurance costs, and holds the SGA until the completion of the borrowing and lending process 1309.

The platform 4 then notifies the borrower about the availability of the shipping label generation function 1400 for the purpose of generating the shipping labels for this particular borrowing, for a limited time 1212. In one embodiment of the present invention, the availability of the shipping label generation function is 48 hours from the time of the platform's notification to the borrower 334, in order to help prevent unauthorized use of the shipping label generation function 1400, and in order to ensure that, in the event the borrower does not complete the borrowing process, the lender's item will become available for borrowing again to other members. Such availability time limit is not a requisite element of the invention, and may be inactivated, or the time limit may be changed. In one embodiment of the present invention, this feature serves as an additional way of enhancing the security and trusted nature of the platform 4 (or invention system).

In other embodiments of the present invention, the platform 4 ensures that borrowed items are shipped only to addresses entered by members at registration, or updated later by such members. This step is performed at the time of shipping label generation by the platform automatically providing the previously entered addresses of the borrower and the lender on the shipping labels. The shipping company that performs the shipping may also perform an address verification of the addresses of the borrower and the lender. Such verifications install trust in the lender that the item is going to be shipped to a trusted address, and the likelihood that such trusted borrower will return the item back to the lender as agreed. In variations of the present invention, such address verification may be performed through different means and by using different methods, or may not be performed at all.

In one embodiment, an alternative feature is provided for printed items being borrowed. Instead of shipping the hardcopy of the subject item, platform 4 allows the lender to generate and upload an image file (e.g., PDF) or similar digital data copy of the subject item. Platform 4 stores the image file/digital data copy (generally “soft copy” or “electronic copy”) in database 30 and allows secured, time-delimited access to the subject image file by a borrower. For example, steps 1402, 1404, 1406 and 1408 of the shipping label generation function 1400 may be employed. Then instead of platform 4 generating shipping labels at step 1410, platform 4 may generate and transmit to the borrower a password protected, read-only, non-copyable/non-downloadable image file of the subject item (i.e., a copy from that stored in database 30) or a link (password protected and time-delimited) to such an image file copy. The access level may limit the borrower from downloading the image file/electronic copy to prevent the borrower from storing/having a copy beyond the borrowing terms. The time delimits of authorized access by the borrower are calculated similarly to the shipping dates of step 1410. After the return ship date, the password, link, etc. expire and prevent the borrower from further accessing the electronic copy of the subject item.

In another embodiment of the present invention, the external payment clearance (if funds are uploaded to the reserve account 1608 by a member through an external payment clearance) may also perform an address or identity verification of the member requesting to upload funds. Such address or identity verification may be applicable for some methods of uploading funds (e.g. using a credit card), and not applicable for other methods of payment (e.g. uploading funds by using an external gold account the member holds with a company, which company may hold assets in gold, with a then-current monetary value of the gold in such accounts). Each external clearance may use different means of verifying the identity of individuals (or organizations), requesting to upload funds from accounts held by such individuals or organizations through such external companies. Such verifications create a level of trust that the borrower is a valid individual or entity. In variations of the present invention, such verifications may be performed through different means, or may not be performed at all.

Returning to step 1410 FIG. 13, the borrower 334 then uses the shipping label generation function 1400 to generate the shipping labels for each way of shipping the item—from the lender to the borrower, and for the return shipping from the borrower to the lender. At the time of the shipping label generation, the platform 4 also calculates the date of shipping by the lender, and the date of the return shipping by the borrower. The platform 4 automatically displays both of these dates in both the borrower's and the lender's profile (e.g., at 1610 in account information 1600), related specifically to this item that is being borrowed. The formula for calculating the dates, based on the duration of the borrowing, is pre-programmed into the platform 4 by the service provider. In one embodiment of the present invention, this feature also serves as an element to add to the trusted nature of the platform 4 and the service. Such dates provide peace of mind to the lender in knowing when to expect the item back, and a reminder for the borrower to fulfill her obligations.

To generate the shipping labels, the platform 4 uses the determined amounts of shipping costs, based on the weight of the item; as well as the shipping insurance costs, based on whether such shipping insurance is required by default based on the SGA being $100 or higher. Or in the event the SGA is lower than $100, the platform 4 checks for possible shipping insurance requirement by the lender. The platform acquires weight and SGA information for a particular item from the information the lender entered at the time of posting the item at 1100 and stored in database 30.

The borrower then sends the first shipping label to the lender 1214, through the messaging system 1200, in the printable format in which the platform saved such labels after generating them. The lender then ships the item to the borrower on the designated date 1016. The borrower, after receiving the item, keeps it until the designated ship back date 1018. In the rarely expected event that the borrower does not ship the item back 1020, the platform 4 knows, after attempted interactions between the lender and the borrower, and interactions between the lender and the service provider (similar to steps 1216 and 1218), that the borrower's RA 1608 will not be credited with any portion of the SGA and the lender's RA 1608 will be credited with the full amount of the SGA 1024. The platform 4 then performs the full credit to the lender 1324.

In most cases, the borrower ships the item back to the lender on or before the designated shipping date 1022, using the shipping label she generated.

In the embodiment of the present invention, some of the shipping providers may offer package pickup (with certain weight and size limitations) at the members' location at no additional cost. Such pickup provides the opportunity for members to perform a borrowing and lending transaction without needing to seek outside assistance, or without the member leaving his location. In variations of the present invention, there may be a number of shipping providers used in the borrowing and lending process, and which shipping providers may or may not offer pickup of packages, or may offer such pickup at additional cost.

Further one or more of the shipping provider companies may offer tracking of packages, which provides the ability to track the arrival, and the arrival date, of an item shipped by either the lender or the borrower. Such tracking provides for ensuring that the borrower and/or the lender did receive the item; provides for tracking the date of arrival of the item; and provides for proof of shipment or arrival (or lack thereof) in case of disagreement between lender and borrower regarding the item. In the preferred embodiment of the invention, such tracking is embedded in the sequence of the borrowing and lending process; however, such tracking is not a requisite element of the invention; therefore, in variations of the present invention, such tracking may be used in different forms, or not used at all.

The lender then receives the item, and inspects it for acceptable condition 1026. If the lender deems the item to not be in acceptable condition 1028, he notifies the borrower 334 by sending a message 1216. The lender and the borrower then engage in a resolution process, based on the condition of the item in which the lender received the item back, and agree on whether a partial SGA 1034 or the full SGA 1036 should be credited back to the borrower's reserve account. If the lender and the borrower agree 1034 that only a partial SGA should be credited back into the borrower's RA 1608, each the lender and the borrower sends a message to the service provider, detailing their agreement with the specific amounts 1218, which messages should include the same information regarding the agreement, and may also serve as proof of the agreement. The service provider then credits the agreed upon amount of the SGA into the borrower's reserve account 1608, and credits the remaining amount of the SGA into the lender's reserve account 1608 as conciliation for the sub-par condition of the item 1324

If the lender and the borrower agree that the borrower should receive the full amount of the SGA back, the lender operates a ‘received in acceptable condition’ function tool 1032, then the platform 4 will know that the full SGA must be credited back 1036 into the borrower's reserve account 1608, and the reserve account function credits 1324 the full SGA into the borrower's reserve account 1608. In one embodiment of the present invention, the platform provider encourages members to resolve such disagreements between themselves. If, however, the borrower 334 and the lender are not able to resolve the disagreement, they may contact the platform provider and ask to facilitate the resolution process. The platform provider takes an unbiased position, and facilitates the resolution between the borrower and the lender without the platform provider making a decision. In the unlikely event of fraud, the platform provider, however, will cooperate with the appropriate agencies.

If the lender deems the item to be in acceptable condition 1030 immediately after inspecting the item 1026, the lender operates the ‘received in acceptable condition’ function tool 1032 on the central platform 20, then the platform 4 knows that the full SGA must be credited back into the borrower's reserve account 1036. The reserve account function then credits 1324 the full SGA into the borrower's reserve account 1608.

In one embodiment of the present invention, the sequence of the requisite elements of the borrowing and lending process is completed with the above last step. An optional step, the rating step is encouraged by the platform provider for both the borrower and the lender to perform.

If either or both the borrower and the lender choose to perform this function, he will access the rating 1500 function that enables each member to rate his counterpart in a transaction on a measurable scale (such as a scale of 1-10), and to write a review of the interaction and experience with such counterpart member 1510. Members are encouraged by the platform provider to include only relevant opinion, and to write such opinion in a subjective tone, encouraging the maintaining of boundaries of acceptable comments by all members. In the embodiment of the present invention, members cannot remove rating or reviews provided by them to other members, or received from other members; however, the service provider reserves the right to remove any inappropriate, offensive, or otherwise wrongful reviews and ratings at its own judgment and/or after notification of such reviews by members. The rating 1500 function serves as an important element in developing and maintaining a trusted network, in which members feel encouraged and confident to participate in the service the platform provider provides.

The completion of the rating of the other member of a specific transaction fully completes such transaction. Members may seek other transactions, as well as they were able to seek other transactions during the duration of any transaction, and at any time when such members' memberships are current. Each member may act either or both as a lender and as a borrower at any time, and simultaneously.

In the embodiment of the present invention, the above described member-specific functions comprise a significant portion of the activities performed on or through the central platform 20. However, in variations of the invention, these functions may not be restricted to members, but be available to any participants. The functions embedded into the platform 4 may also vary in terms of the types of processes such functions perform and provide, as well as in the availability of such functions to any specific group or category of participants. Therefore, the above described functions and their exclusivity to the embodiment of the present invention is in no way intended to limit the variations of any currently available or existing, or not-yet available or existing, functions, or the fact of whether they are included in the embodiment thereof, that enables members to borrow and lend items through the platform.

Many variations of the present invention are possible once the present invention is known to those skilled in the arts and are within the spirit and the scope of the present invention. Those skilled in the arts will be able to make many variations on the present invention once this invention is known to the arts. For example, the platform service provider may allow lenders to charge borrowers a fee for borrowing an item (physical or electronic). The platform service provider may allow lenders to charge borrowers a fee for buying the electronic copies of the image scanned items. The platform service provider then may take a percentage of the lender's incoming fee revenue. Credits to, withdrawals from and funds transfers between the Reserve Accounts of the lenders and borrowers may be used for this purpose.

While this invention has been particularly shown and described with references to example embodiments thereof, it will be understood by those skilled in the art that various changes in form and details may be made therein without departing from the scope of the invention encompassed by the appended claims.

What is claimed is:

1. A system for presenting a data record of a good for temporary exchange to a market for goods for temporary exchange, comprising:
in a wide area communication network, means for presenting and offering goods for temporary exchange from lenders to borrowers, a registration means for said borrowers and said lenders to register with the system for participating in said temporary exchange, a user interface to connect to said wide area communication network for said borrowers and said lender to post/depost items with said data for declaring the availability of said items for said temporary exchange, a database means for storing and tracking said data record of said good for temporary exchange and said registration record of said borrowers and lenders, a communications means for communicating with said system and said borrower and said lender to accept said registration data record of said borrower and said lender and to accept data record of said good for temporary exchange, a security fund depository means for said borrower to deposit funds for securing said lender's agreement for said temporary exchange and for said borrower to have a depository means for transferring funds for the cumulative said related expenses of said good for temporary exchange, a payment clearing means for processing a payment request for related expenses of said temporary exchange from said borrower;
a central server computer for providing said features for said borrowers and said lenders;
a user interface for receiving textual, imagery and sound information between said borrower and said lender and said central server's administrator;
a computer locally connected at each said lender's and said borrower's and said central server's administrator's location to said communication means, said user interface, said storage device, and
said computer adapted to generate a data record of said good for temporary exchange and a data record of said borrower's and said lender's registration information, said computer adapted to receive said digital image or sound means, incorporate said digital image or sound means into said data record of said good for temporary exchange.

2. The system of claim 1, wherein said post/depost system of said system provides for said lender to post said items with various identifying information of said item to make said item available for said borrowers in said market to borrow said items, where said identifying information may take form in textual, imagery, sound, or other forms of digital, electrical or otherwise known or not-yet known means, and where said identifying information is entered into said system by said participant through said computer locally connected to said system through said communications network at said participant's location.

3. The system of claim 1, with the addition of a search/peruse means for said participants to search, peruse and find said items posted by said lenders on said user interface, for said participants to gain information of said items, and to provide the opportunity for said participants to develop a desire to borrow said items, and to provide the opportunity for said participants to know the location of said item on said user interface for the purpose of initiating said temporary exchange transaction if said participant wishes to initiate said temporary exchange transaction.

4. The system of claim 1, wherein said communications means is in the form of a messaging means, operationally connecting said borrowers and said lenders and said administrator of said system, where said communications means may be manually executed by said participants and said administrator of said system or said communications means may be executed automatically by said system when said participants engage in using the various means acting as parts of using said system and where said means are described in claims 1-12 or may include claims not described or not yet invented but may be apparent to a person skilled in the art, having a main purpose of providing said communication between said borrowers and said lenders for the arrangement of said transactions of temporary exchange of said items, and said communications means having an additional purpose of providing said communication between said administrator of said system and said borrowers and said lenders for the purpose of communicating regarding said temporary exchange transactions, communicating regarding said borrowers' and lenders' said registration information or data information said borrowers and said lenders entered into said database relating to said items posted by said lenders, for said administrator of the system to transmit required or desired information to said borrowers and said lenders, and for the purpose of having a means of facilitating by said administrator of the system any required conciliation between said borrows and said lenders.

5. The system of claim 1, wherein said security fund depository means, having a purpose of providing a depository for funds by said borrowers to upload funds to secure said temporary exchange transaction with said lender to provide said lender with a security assurance of providing an alternative means of value, specified by said lender, of said item being temporarily exchanged between said lender and said borrower, and having a purpose of providing a central depository of funds by said borrowers to upload funds to satisfy payment obligations related to said temporary exchange transactions, serves in developing a secure and trusted network of said market for goods for said temporary exchange, and to facilitate said fund transfer needs related to said temporary exchange transactions.

6. The system of claim 5, wherein said upload funds feature relating to said security fund depository means is comprised of one or more connections to one or more external payment clearance, or may contain means of manual manner of said fund upload (e.g. a member may send a check, and his reserve account will be manually credited).

7. The system of claim 1, with the addition of a shipping label generation means to facilitate the preparation of requisite documentation for shipping by external shipping service provider of said item for said temporary exchange arranged between said lender and said borrower, and to provide for convenience for said borrower and said lender in preparing said requisite documentation for said shipping of said item, with the feature of said system automatically calculating costs of said shipping based on said data record entered into said system specific to said item by said lender at the time of said post/depost operation of said item by said lender and on shipping rates data received by said administrator of said system from said external shipping service provider and entered into said database of said system by said administrator of said system prior to arrangement of said temporary exchange transaction between said lender and said borrower.

8. The system of claim 7, with the addition of a means to provide shipping insurance for said item being shipped between said lender and said borrower, with the feature of said system automatically calculating costs of said shipping insurance based on said data record of said item entered into said database of said system by said lender at the time of said post/depost operation of said item by said lender and on shipping insurance rates data received from shipping insurance providing external entity and entered into said database of said system by said administrator of said system prior to arrangement of said temporary exchange transaction between said borrower and said lender.

9. The system of claim 1, with the addition of a rating means to provide for said borrower and said tender to rate each other on a measurable scale and to write a review of each other and of said temporary exchange transaction for the purpose of said rating and said review becoming visible to all said participants using said user interface, and to assist said participants to distinguish between desirable and trustworthy borrowers and lenders based on individual or cumulative rating data and review information provided by borrowers and lenders previously engaged in temporary exchange transactions with said borrower or said lender previous to said temporary exchange transaction.

10. The system of claim 1, with the addition of an ‘account information 1600’ means for said registered participants to view their ‘account information 1600’, consisting of said registration information, said data and information entered into said system during the post/depost operation of said items posted by said participant, said participant's messages with other participants and said administrator of said system, said participant's reserve ‘account information 1600’, said participant's shipping label generation information, said participant's rating performed by said participant regarding participants with whom said participant previously engaged in temporary exchange transaction as well as said rating information said participants received form participants with whom said participant previously engaged in temporary exchange transactions.

11. The system of claim 1, with the addition of a compiling and/or aggregating means of said data entered into said database by said participants regarding said goods available for said temporary exchange transactions and data and information entered into said database by non-registered participants or by said administrator of said system or designees of said administrator of said system for the purpose of informational and educational viewing or use, where said compiling and/or aggregating of said data and said information may be performed for informational or educational purposes for selected or any participants or selected or any individuals or entities in the World as determined by said administrator of said system by the administrator of said system deriving or not deriving monetary or other advantages for said compilation and/or aggregation and/or sharing of said data and information, where said compiled and/or aggregated data and information may become significant in volume, scope, content, quality, scientific measures, historic measures or in other ways of said compilation and/or aggregation potentially becoming significant in not yet mentioned, measured or not yet existing terms.

12. The system of claim 1, where said market is created largely by the existence of said system, said system offering a “place” of cumulative information of available said goods for temporary exchange and offering a “place” for said participants to find said goods available for temporary exchange, offering the opportunity for said participants to arrange said temporary exchange transactions between themselves through said system, and offering the necessary tools for said participants to arrange said temporary exchange transactions between themselves through said system.
